(19) United States
(12) Patent Application Publication
(10) Pub. No.: US 2005/0034542 A1
(43) Pub. Date: Feb. 17, 2005

(54) Sensor comprising mechanical amplification of surface stress sensitive cantilever

(76) Inventor: Jacob Thaysen, Copenhagen (DK)

Correspondence Address: JACOBSON HOLMAN PLLC, 400 SEVENTH STREET N.W., SUITE 600, WASHINGTON, DC, 20004, US

(21) Appl. No.: 10/502,660

(22) PCT Filed: Feb. 10, 2003
(86) PCT No.: PCT/DK03/00086

(30) Foreign Application Priority Data
Feb. 8, 2002 (DK) PA 2002 00195

(51) Int. Cl. G01L 1/22

(52) U.S. Cl. 73/862.634

(57) ABSTRACT

The invention relates to a sensor comprising one or more sensor units, wherein at least one of the sensor units is in the form of a poly-cantilever structure. The poly-cantilever structure comprise two or more cantilever-like structures, at least one of the cantilever-like structures comprises a piezoresistive element, and at least one of the cantilever-like structures comprises a capture surface, at least one cantilever-like structure with a piezoresistive element designated a piezoresistive cantilever being connected in an amplifying connection to at least one of the cantilever-like structure with a capture surface designated a capture surface cantilever. The amplifying connection being provided so that a deflection of said capture surface cantilever due to a stress generated at said capture surface being capable of deflecting the connected piezoresistive cantilever. The sensor can be used for detection of a target substance in a fluid, such as a gas or a liquid.

### FIELD OF THE INVENTION

The present invention relates to a sensor comprising one or more sensor units, wherein each sensor units comprises a capture surface area and a piezoresistive detection system, for direct detection of stress change of the sensor unit. One type—the most commonly used type of sensor unit—is a cantilever.

### BACKGROUND OF THE INVENTION

In the art of detecting components in fluids, cantilever based sensors with integrated piezoresistors are used as very sensitive mechanical stress sensors. As described in e.g. WO 0066266 and WO 9938007, micro cantilevers can be used for detection of molecular interaction. At least one surface of the cantilever is coated with a capture layer, which capture layer reacts with a target molecule of interest. If the cantilever is exposed to a sample in which the target molecule is present, the target molecule will react with the capture molecule on the cantilever surface and a surface stress change will be generated.

Due to the surface stress change of the cantilever, a mechanical compression, stretch or decompression is applied to the cantilever and thereby also to the piezoresistor, and thereby the resistivity of the piezoresistor changes its value. The mechanical compression or decompression may result in a deflection and/or a stretch. By measuring the change in resistance, it can be determined whether the target molecule is present in the sample or not, and if so it may also be possibly to detect the concentration of the target molecule.

Cantilever-based sensors with integrated piezoresistive read-out are described by Thaysen, Ph.D. Thesis, “Cantilever for Bio-Chemical Sensing Integrated in a Microliquid Handling System”, September 2001, Microelektronik Centeret, Technical University of Denmark. Hereby the stress changes on the cantilever sensors can be measured directly by the piezoresistor. Moreover, integrated read-out greatly facilitates operation in solutions since the refractive indices of the liquids do not influence the detection as it will using optical read-out. Each sensor may have a built-in reference cantilever, which makes it possible to subtract background drift directly in the measurement. The two cantilevers may be connected in a Whetstone bridge, and the stress change on the measurement cantilever is detected as the output voltage from the Whetstone bridge.

In order to use microcantilevers with integrated piezoresistors for biochemical detection, it is desired to be able to detect very small surface stress changes. The better the surface stress change resolution is, the fewer and weaker molecular interactions can be detected. This is for example important when the detection is used for diagnostic applications, where the molecule of interest is of very low concentration in the sample.

The objective of the present invention is therefore to provide a sensor comprising one or more sensor units with a capture surface, which sensor can be used for detection of the presence of a target in a fluid, such as a biocomponent in a liquid or a gas, with an improved signal, in particular where the molecule of interest is of very low concentration in a liquid sample.

This and other objectives have been achieved by the invention as defined in the claims.

### DISCLOSURE OF THE INVENTION

The invention is build on the observation by the inventor, that the change in resistance in the piezoresistor of a of prior art sensors is only picked-up in places where the surface stress acts, thus the sensitivity can be considered locally only. This means that the cantilever sensor unit will exhibits constant curvature in places where a surface stress is induced, but be straight and unaffected where no surface stress is obtained. This means that the surface stress only acts locally on the piezoresistor. Therefore the build-in piezoresistive element is only sensitive to local surface stress changes.

Based on this observation the inventor found the mechanical amplification principle for the surface stress sensitive sensor unit which forms basis for the present invention

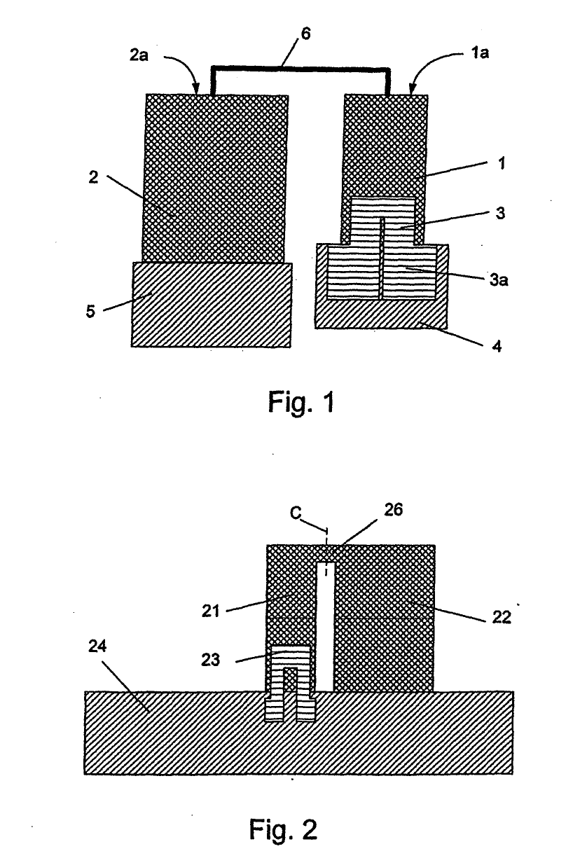

In a simple embodiment the sensor according to the invention may consist of two cantilevers one A carrying a capture surface and one B comprising a piezoresistor, which cantilevers are connected in their free end to form a poly-cantilever, e.g. as shown in FIG. 1. The surface stress acts on cantilever A, and thereby bending it with a constant curvature and thereby constant stress distribution. This will force cantilever B to bend, and since the two cantilevers are connected at the free ends, cantilever B will experience a point force at the end of the cantilever. The stress increases linearly along the length of the cantilever B. Since the stress level therefore is largest at the base of the cantilever also referred to as its substrate. The piezoresistive element is placed here in order to pick-up the amplified signal.

The sensor of the invention comprises one or more sensor units. The shape and size of the sensor and the size, and the number of sensor units as well as its wiring, may e.g. be as disclosed in any one of the patent applications WO 0066266, DK PA 2001 01724 DK PA 2002 00283, DK PA 2002 00125 and DK PA 2002 00195, which with respect to the disclosure concerning sensor structure and size (not sensor unit structure), materials, wirering, type of capture surface, and fluid chamber structure and size are hereby incorporated by reference.

In the following the sensor is described with one sensor unit, only, but it should be understood that the sensor unit may have several sensor units, such as up to 300, e.g. up to 100.

The sensor unit is in the form of a poly-cantilever structure. By the term poly-cantilever structure means a structure comprising two or more cantilever-like structures, such as 3, 4, or 5 cantilever-like structures. A cantilever-like structure is defined as a structure which is linked to and protrudes from a base also called a substrate. In one embodiment it is desired that the cantilever-like structure is flexible.

The term “flexible” used in relation to the sensor unit means that the sensor unit should be capable of deflecting, e.g. due to stress formed in the surface stress sensing element or due to amplification using an amplifier.

In one embodiment the cantilever-like structure is a structure that protrudes from a substrate and is capable of being deformed (deflected) due to a deformation force of 10⁻³ N or less, such as of 10⁻⁵ N or less, such as of 10⁻⁷ N or less, such as of 10⁻⁹ N or less, such as of 10⁻¹⁰ N or less.

The poly-cantilever structure comprises two or more cantilever-like structures. The cantilever-like structures is mechanical connected to each other at a distance from their respective substrates. The connection may in one embodiment be a directly connection i.e. the two or more cantilever-like structures are in direct contact with each other. In another embodiment the cantilever-like structures are connected to each other via a connecting element e.g. shaped as a bidge. In this embodiment it is desired that the connecting element should be sufficiently rigid to transfer at least 10% such as at least 25%, such as at least 50% of a deflection from one cantilever-like structures to another cantilever-like structures connected by the connecting element. In one embodiment, the connection element having an average flexibility which is lower than the average flexibility of the piezoresistive cantilever. In one embodiment the connection element is sufficient rigid to remain undeformed when subjected to a force of up to 10⁻¹⁰ N. In one embodiment the connection element is sufficient rigid to remain undeformed when subjected to a force of up to 10⁻⁵ N. In one embodiment the connection element is sufficient rigid to remain undeformed when subjected to a force of up to 10⁻⁵ N.

At least one of the cantilever-like structures of a poly-cantilever comprises a piezoresistive element, and at least one of the cantilever-like structures of a poly-cantilever comprises a capture surface.

In the following a cantilever-like structure with a piezoresistive element will also be designated “a piezoresistive cantilever”, and a cantilever-like structure with a capture surface will also be designated “a capture surface cantilever”.

The cantilever-like structures of a poly-cantilever are connected so that at least one piezoresistive cantilever is connected to at least one capture surface cantilever. The connection is designated “an amplifying connection” which means that a deflection of the capture surface cantilever due to a stress generated at its capture surface is capable of deflecting the connected piezoresistive cantilever.

The cantilever-like structures may in principle have any shape as long as they are linked to each other and that they are relatively flexible as described above. In one embodiment the cantilever-like structures is sheet-formed with an average thickness that is less than both its average length and its average width.

In one embodiment the thickness of the sensor unit is between 0.1 and 25 μm, more preferably between 0.3 and 5 μm, such as about 1 μm. The other dimensional parameters, thickness, width and or diameter, may preferably be up to about 500 μm, more preferably up to about 100 μm, such as about 50 μm.

In one embodiment, the respective cantilever-like structures has an average thickness of at least 5 times, preferably at least 50 times less than its average width, and/or the respective cantilever-like structures has an average thickness of at least 5 times, preferably at least 50 times less than its average length. As the cantilever-like structures in one embodiment may have shapes with no unambiguous definition of width and length, e.g. rounded or circular shapes, it is in this embodiment preferred that such cantilever-like structure has an average thickness of at least 5 times, preferably at least 50 times less than its other dimensions including width, length and diameter.

In one embodiment the respective cantilever-like structures being in the form of a sheet formed unit linked to a substrate and protruding there from. The periphery of the cantilever-like structure is determined as the line along the cantilever edge, the connection line to the substrate and the one or more connection lines to other cantilever-like structures. The connection lines are determined as straight lines. The periphery of the cantilever-like structures may be regular or irregular. In one embodiment the periphery of the cantilever-like structure is independently from each other selected between square formed, rectangular, triangular, pentagonal, hexagonal, leaf shaped, circular and oval periphery.

As mentioned above, a connection line between to cantilever-like structures is determined as a straight line. In some structures an exact connection line between two cantilever-like structures is not simple to determine because the cantilever-like structures at the area of the connection comprise a protuberance. In such situation the cantilever connection line is determined as the shortest line through the protuberance. In case there is an area where a line through the protuberance can be shortest so that several lines of equal shortest length could be made i.e. an area where the protuberance is narrowest, the cantilever connection line is a midline through the protuberance at the area where it is narrowest.

In some structures an exact connection line between two cantilever-like structures is not simple to determine because the cantilever-like structures are “overlapping” or are “grown” into each other. In such situation the cantilever connection line is determined as the shortest line between the cantilever-like structures.

In one embodiment the poly-cantilever structure comprises two, tree or four cantilever-like structures, the cantilever-like structures preferably having equal shape.

The cantilever-like structures of a poly-cantilever may be linked to the same substrate or to different substrates. The cantilever-like structures may be linked to the substrate by being integrated to each other or by a connection means e.g. a glue of a click lock. In one embodiment the cantilever-like structure and the substrate are produced separately of each other, at east one of the cantilever-like structure and the substrate comprise a thermoplast, the cantilever-like structure and the substrate being held together and heated to thereby fixate the cantilever-like structures to the substrate. Similarly the cantilever-like structures may be connected to each other after their production.

In one embodiment the cantilever-like structures and the substrate are produced as a single unit i.e. integrated with each other. In this embodiment it is often desired that the basic material of the cantilever-like structures is also the basic material of the substrate. The term “basic material” means the major part by volume of the material exclusive the material of the capture coating, the piezoresistive element and the wiring.

The connection between a cantilever-like structure and its substrate may be identified according to its material thickness i.e. the substrate is more rigid than the cantilever-like structure, e.g. more than 3, 5 or 10 times as rigid as the sensor unit. The substrate may e.g. be thicker than the cantilever-like structure, e.g. more than 3, 5, 10 or 25 times as thick as the cantilever-like structure.

As mentioned above the connection line between a cantilever-like structure and its substrate, is determined as a straight line. This means in practice that the connection line is determined by following the edge of the cantilever-like structure until a first connection point to the substrate, determining the second connection point by following the true connection, and drawing a straight line between the to points.

The %-vice connection distance of a connection between two cantilever-like structures to their respective substrates being determined individually for each cantilever-like structure. The %-vice connection distance of a connection of a first cantilever-like structure to another also designated a cantilever connection line and the substrate linked to said first cantilever-like structure, is determined as the shortest distance between the cantilever connection line and the substrate connection line. The %-vice distance being in % of the total length of the protruding first cantilever-like structure. The length of the cantilever-like structure is determined as the longest distance from the remotest part of the cantilever-like structure to the middle of the substrate connection line.

In one embodiment the two or more cantilever-like structures of a poly-cantilever structure are connected to each other at a connection distance for one or preferably both cantilever-like structures which is 50% or more, such as 70% or more, Such as 90% or more.

In one embodiment the cantilever-like structures is connected to each other at a connection line with a connection distance for both cantilever-like structures which is 95% or more. This is referred to as being their free end. In case of a traditional rectangular cantilever the fee end includes the edge which is farthest away from the substrate to which it is linked. In one embodiment the connection between the cantilever-like structures being in the form of a joining along a length section of the periphery of at least one of the cantilever-like structures, i.e. a section of the periphery which do not include the free ends of at least one of the cantilever-like structures.

In one embodiment the poly-cantilever structure has an essentially rectangular or square formed periphery. The two or more cantilever-like structures of the poly-cantilever structure are connected to each other at their free edge, wherein the free edge of the cantilever is the edge which is farthest away from the substrate to which it is linked. The piezoresistive cantilever is preferably connected to the one or more other cantilever-like structures along 60% or less, such as 40% or less, such as 20% or less of the length of the free edge of the piezoresistive cantilever. In one embodiment the connection e.g. via a connection element is located to at least cover the median of the free edge line.

The cantilever-like structures may in one embodiment be placed parallel to each other. This means in practice that the protruding directions are parallel. The protruding direction of a cantilever-like structure is determined as the direction measured from the median of the substrate connection line to the remotest part of the cantilever-like structure.

In one embodiment the cantilever-like structure of the poly-cantilever structure protrudes in directions from their respective substrates which directions has/have an angle or angles to each other which is/are within the interval 0 to 45°, preferably the directions has/have an angle or angles to each other which is/are within the interval 0 to 15°.

As described above it is in one embodiment desired that the cantilever-like structures has a high flexibility. In this connection it can further be added that in general the lower force necessary to deflect the piezoresistive cantilever, the higher is its sensitivity.

The flexibility of the respective cantilever-like structure may in one embodiment be equal over its extension from the substrate connection line and towards its free end.

In one embodiment the flexibility of the piezoresistive cantilever is varying over its extension from the substrate line and towards its free end, the flexibility preferably being highest at a distance from the substrate which is 50% or less, such as 30% or less of the length of the protruding cantilever.

The piezoresistive element is normally partly integrated or protrudes into the substrate where it is connected to two wires. The piezoresistive element may in one embodiment have an extension into the piezoresistive cantilever to a distance from the substrate connection line which is 80% or less, such as 50% or less, such as 30% or less of the length of the protruding cantilever. By providing the piezoresistive cantilever with a high flexibility in areas of the cantilever where it contains the piezoresistive element, an increased signal may be obtained.

The sensitivity of the sensor with a sensor unit as described above is in general relatively high compared to prior art sensors, since the stress generated on one surface area and resulting in a deflection, can be transferred to another cantilever-like structure in the form of the deflection. In one embodiment the capture surface cantilever has a larger surface area than the piezoresistive cantilever, thereby a high deflection can be detected particular when concentrations of a target substance in a liquid or gas is low.

In one embodiment of the sensor according to the invention the surface stress change acting on a capture surface cantilever can be concentrated to act on a small part of the piezoresistive cantilever. For example if a surface stress of 1 N/m is acting on a cantilever area of 1000 μm2, this may be concentrated down to act on an area of 10 μm2,. Thereby the stress change in that area would be 100 N/m and thereby increasing the sensitivity 100 times.

In one embodiment the poly-cantilever comprises two or more capture surface cantilevers, thereby an even higher signal may be obtained.

In one embodiment the piezoresistive cantilever also comprises a capture surface. The piezoresistive element may in such circumstances be insulated in particular if the sensor is designed for use in detecting of a target substance in a liquid. The insulation of the piezoresistive element may e.g. be as described in WO 0066266.

In one embodiment where the piezoresistive cantilever do not comprise a capture surface, the piezoresistive element need not be insulated even if used in detecting of a target substance in a liquid, because the piezoresistive cantilever do not need to come into contact with the liquid. Thereby the sensor may be much more simple to produce because steps of insulating the piezoresistive element may be omitted.

The cantilever-like structures as well as the substrate may e.g. be from materials selected from silicon, silicon oxide, silicon nitride, metals, polymers, glass compositions, ceramics, plastics or any combinations of these materials.

The group of polymers preferably includes epoxy resin, polystyrene, polyethylene, polyvinylacetate, polyvinylcloride, polyvinylpyrrolidone, polyacrylonitrile, polymethylmetacrylate, polytetrafluoroethylene, polycarbonate, poly-4-methylpentylene, polyester, polypropylene, cellulose, nitrocellulose, starch, polysaccharides, natural rubber, butyl rubber, styrene butadiene rubber and silicon rubber.

In order to have optimal processability, the substrate should preferably be of or comprise a material which can act as a photo resistor. Preferred materials include an epoxy resin, preferably selected from the group consisting of epoxy functional resin having at least two epoxy groups, preferably an octafunctional epoxidized novalac. Particularly preferred materials are described in U.S. Pat. No. 4,882,245 which is hereby incorporated by reference. The most preferred material is the octafunctional epoxidized novalac which is commercially available from Celanese Resins, Shell Chemical, MicroChem Inc under the tradename SU-8, and from Softec Microsystems under the tradename SM10#0.

For applications in liquid, the wires need to be insulated, and the substrate should therefore preferably consist of or comprise an electrically insulating material, which prevents short-circuiting of the electrical connections during operation. The insulating material could e.g. be a polymer, silicon nitride, silicon oxide, metal oxides, etc. In case the electrical connection line includes doped silicon, the insulating property can be obtained by reversed biased diode effect. For a wire consisting of p-type silicon, the reversed biased diode effect is obtained by encapsulating the wire in n-type silicon.

The sensor according to the invention includes an electric communication line for applying a voltage over the piezoresistive element. The electric communication line includes a pair of wires connected to the piezoresistive element. The wires may be of the same material as the piezoresistive element. In the situation where the wires and the piezoresistor are of the same material, the piezoresistor will preferably be thinner, e.g. a thinner layer or a smaller wire diameter. In other situations the wires and the piezoresistor are of different materials and are fixed to each other at a connection point e.g. by welding. The method of connecting wires to a piezoresistive element is generally known in the art, and reference is made to the prior art referred to above. The electric communication line may consist of the wires, but it may also include other elements such as diodes, other resistors, e.g. a part of a Whetstone bridge.

In one embodiment the wires are integrated in the substrate and insulated as described above.

The piezoresistive element may comprise or preferably consist of a material selected from the group consisting of amorph silicon, polysilicon, single crystal silicon (p-type or n-type), metal or metal containing composition, e.g. gold, AlN, Ag, Cu, Pt and Al conducting polymers, such as doped octafunctional epoxidized novalac e.g. doped SU-8, and composite materials with an electrically non-conducting matrix and a conducting filler, wherein the filler preferably is selected from the group consisting of amorph silicon, polysilicon, single crystal silicon, metal or metal containing composition e.g. gold, AlN, Ag, Cu, Pt and Al, semi-conductors, carbon black, carbon fibres, particulate carbon, carbon nanowires, silicon nanowires and nanotubes. As used herein, a “nanotube” is a nanowire that has a hollowed-out core and includes those nanotubes know to those of ordinary skill in the art. A “non-nanotube nanowire” is any nanowire that is not a nanotube. Further information about useful nanowires can be found in WO 0248701 which is hereby incorporated by reference.

Piezoresistive elements are well known in the art and further information can be found in the following publications which with respect to the disclosure concerning piezoresistive elements are hereby incorporated by reference: U.S. Pat. Nos. 6,237,399, 5,907,095, Berger, R. et al. Surface stress in the self-assembly of alkanethiols on gold. Science. 276, 2021-2024 (1997); Berger, R., Gerber, Ch., Lang, H. P. & Gimzewski, J. K. Micromechanics: A toolbox for femtoscale science: “Towards a laboratory on a tip”. Microelectronic Engineering. 35, 373-379 (1997); Thaysen, J., Boisen, A., Hansen, O. & Bouwstra, S. AFM probe with piezoresistive read-out and highly symmetrical Whetstone bridge arrangement. Proceedings of Transducers+ 99,1852-1855 (Sendai 1999); Boisen A., Thaysen J., Jensenius H., & Hansen, 0. Environmental sensors based on micromachined cantilevers with integrated read-out. Ultramicroscopy, 82, 11-16 (2000).

The capture surface of the poly-cantilever may e.g. be in the form of a capture coating. The capture coating may e.g. be as described in any one of the applications DK PA 2002 00283 and DK PA 2002 00125 or in U.S. Pat. No. 6,289,717, WO 0133226 or WO 0014539, which with respect to the disclosure concerning the capture surface are hereby incorporated by reference.

In one embodiment of the sensor according to the invention, the capture surface is a surface of a capture coating comprising a capture layer, wherein said capture layer is a layer comprising a detection ligand, said detection ligand being a member of a specific binding pair wherein said detection ligand preferably is selected from the group consisting of RNA oligos, DNA oligos, PNA oligos, proteins, peptides, hormones, blood components, antigen and antibodies.

The capture coating could in principle have any thickness. If the capture coating is very thick the sensitivity may be reduced due to stiffness of sensor unit. A desired thickness could e.g. be from molecular thickness to 2000 nm, such as up to, 2, 5, 10 or 50 molecule layers, or e.g. between 0.5 nm and 1000 nm, such as between 1 and 500 nm, such as between 10 and 200 nm.

In one embodiment both or a part of both of the two major sides of the capture surface cantilever comprise a capture surface. The capture surfaces may be identical or they may differ from each other e.g. with respect to size of area covered, type of capture molecules and/or concentrations thereof. In one embodiment the capture surface on one major side of a cantilever-like structure is essentially identical,—both with respect to size of area covered, type of capture molecules and concentrations—to the capture surface on the other one of the two opposite major surfaces of the capture surface cantilever. In this situation the stress generated on the capture surface cantilever when subjected to a liquid containing the target molecules, will be equal on both sides of the capture surface cantilever.

The sensor may preferably comprise one or more fluid chambers. In one embodiment the one or more sensor units partly or totally protrudes into the fluid chamber(s) so that a fluid e.g. liquid applied in the chamber is capable of coming into contact with part of the surface of the sensor unit(s).

The fluid chamber or chambers may e.g. be in the form of interaction chamber(s), preferably comprising a channel for feeding a fluid, such as liquid into the interaction chamber(s).

In one embodiment at least 50%, more preferably substantially all of the capture surface of the sensor unit or units is positioned inside the liquid interaction chamber(s).

In one embodiment the capture surface cantilever being placed in a flow system e.g. a liquid flow system.

The sensor may e.g. be prepared as described in DK PA 2002 00884 DK with the sensor units is in the form of poly-cantilevers.

### EXAMPLES

Embodiments of the invention will be described further with reference to the figures.

FIG. 1 is a schematic illustration of first poly-cantilever shown as a sectional top cut.

FIG. 2 is a schematic illustration of second poly-cantilever shown as a sectional top cut.

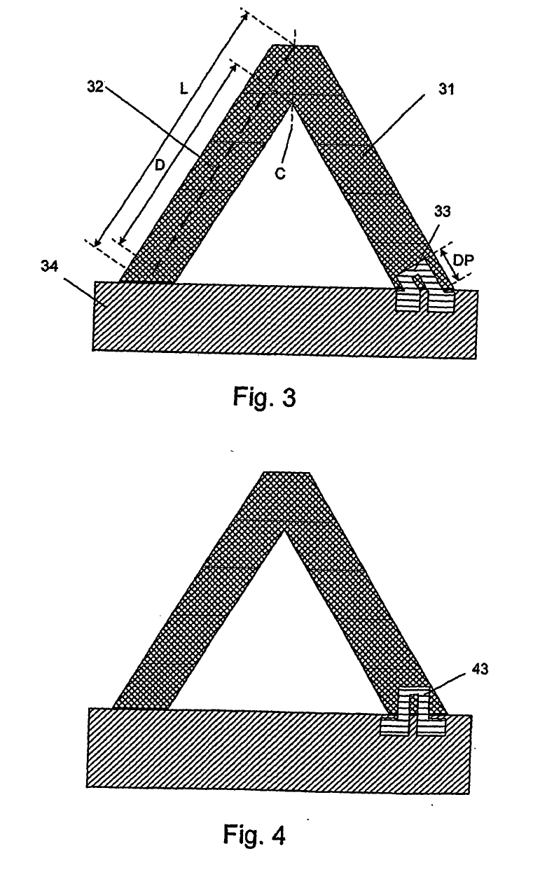

FIG. 3 is a schematic illustration of third poly-cantilever shown as a sectional top cut.

FIG. 4 is a schematic illustration of fourth poly-cantilever shown as a sectional top cut. The fourth poly-cantilever is a variation of the poly-cantilever shown in FIG. 3.

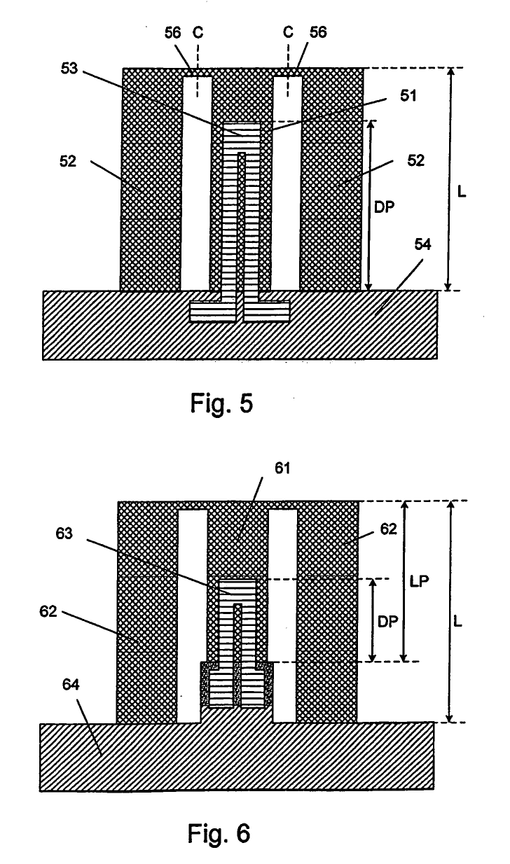

FIG. 5 is a schematic illustration of fifth poly-cantilever shown as a sectional top cut.

FIG. 6 is a schematic illustration of sixth poly-cantilever shown as a sectional top cut. The sixth poly-cantilever is a variation of the poly-cantilever shown in FIG. 5.

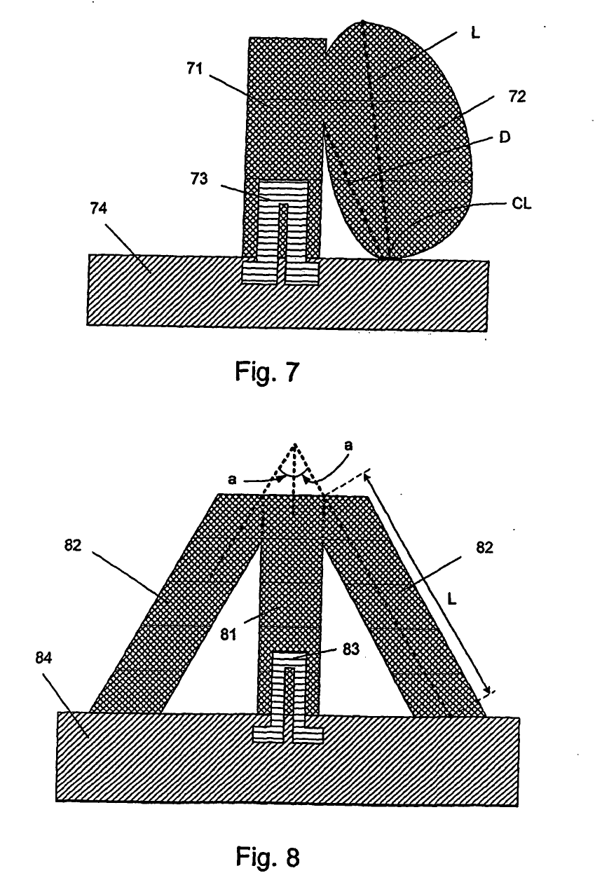

FIG. 7 is a schematic illustration of seventh poly-cantilever shown as a sectional top cut.

FIG. 8 is a schematic illustration of eighth poly-cantilever shown as a sectional top cut.

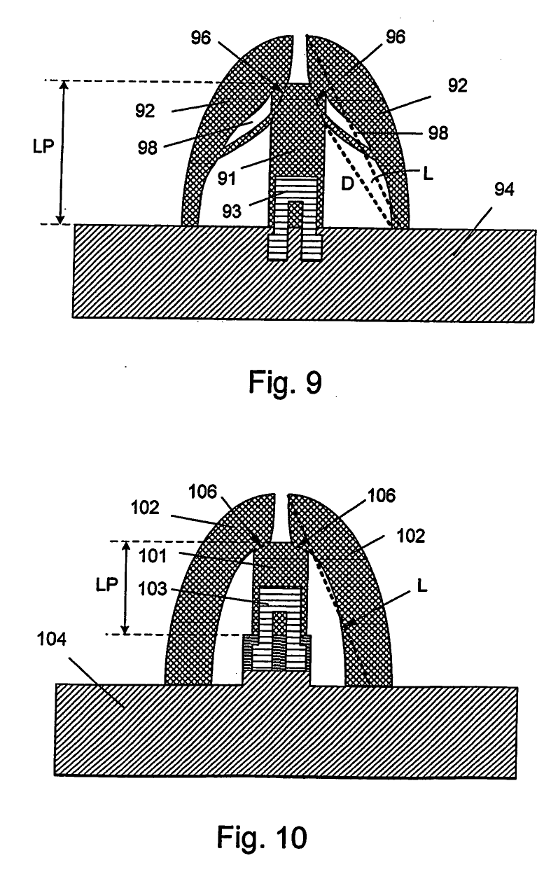

FIG. 9 is a schematic illustration of ninth poly-cantilever shown as a sectional top cut.

FIG. 10 is a schematic illustration of tenth poly-cantilever shown as a sectional top cut. The sixth poly-cantilever is a variation of the poly-cantilever shown in FIG. 9.

The poly-cantilever shown in FIG. 1 comprises a capture surface cantilever 2, and a piezoresistive cantilever 1 with an integrated piezoresistive element 3. The piezoresistive cantilever is linked to a substrate 4, and the capture surface cantilever is linked to a substrate 5. The cantilever-like structures 1, 2 both have a rectangular periphery, and have each a free edge 1a, 2a. The cantilever-like structures are connected to each other at their free edge 1a, 2a, via a connecting element 6, which connecting element is fixated to their respective free edges 1a, 2a, approximately at the median of the respective free edges 1a, 2a.

The piezoresistive element 3 resembles a horse-shoe, and may be covered by a not shown in shape may be covered by a non-conductive material. The non-conductive material may e.g. be the material of the substrate 4 and/or the piezoresistive cantilever 1. Not shown wires are connected to the piezoresistive cantilever 1, at its contact pads 3a, which are integrated in the substrate 4.

The capture surface cantilever 2, comprises a not shown capture coating on one of its major sides. When the capture surface cantilever 2 is subjected to a fluid e.g. a liquid comprising a target substance for the capture coating a stress will be generated on the surface, which will result in a deflection of the capture surface cantilever 2. The capture surface cantilever 2 will bend with a constant curvature if the capture surface cantilever 2 is equally flexible along its length, otherwise the curvature may vary accordingly. Due to the connection with the piezoresistive cantilever 1, via the connecting element 6, the capture surface cantilever will force the piezoresistive cantilever 1 to deflect accordingly. The piezoresistive cantilever 1 will experience a point force at the end of the cantilever. The piezoresistive element 3 is placed in the area where most deflection will be generated in order to pick-up the amplified signal.

In FIG. 2 another poly-cantilever is shown. This poly-cantilever also comprises a capture surface cantilever 22, and a piezoresistive cantilever 21 with an integrated piezoresistive element 23. The piezoresistive cantilever is linked to a substrate 24, and the capture surface cantilever is linked to the same substrate 24. The cantilever-like structures 21, 22 are connected to each other in an area where the cantilever-like structures 21, 22 comprise a protuberance 26.

As mentioned above, a connection line between to cantilever-like structures is determined as a straight midline through the narrowest area of the protuberance. The cantilever connection line C is therefore a midline through the protuberance 26 at the area where it is most narrow. The piezoresistive element 23 is shaped as in FIG. 21 as in all of the following figures and is connected to not shown wires and insulated accordingly.

As seen the piezoresistive cantilever 1 is smaller than the capture surface cantilever 22. The capture surface cantilever 22 therefore have a large capture coating which makes the poly-cantilever very sensitive towards a target substance in small concentrations.

In FIG. 3 a third poly-cantilever is shown. This poly-cantilever also comprises a capture surface cantilever 32, and a piezoresistive cantilever 31 with an integrated piezoresistive element 33. The piezoresistive cantilever is linked to a substrate 34, and the capture surface cantilever 32 is linked to the same substrate 34. The cantilever-like structures 31, 32 are connected to each other in their remotest end. The length of the capture surface cantilever 32 is illustrated with L and the connection distance for the capture surface cantilever 32 is illustrated with D. As seen the connection distance D is approximately 80% of the length L of the capture surface cantilever 32.

The piezoresistive element 33 has an extension into the piezoresistive cantilever 31 to a distance DP from the substrate which is about 15-20% of the length of the protruding cantilever 31.

FIG. 4 shows a variation of the poly-cantilever shown in FIG. 3, with the only difference that the piezoresistive 43 element has another orientation. This may be relevant in case the piezoresistive element is of an anisotropic material such as of single crystalline silicon n-type or p-type. Thereby the piezoresistive element may be orientated so that the highest possible signal can be obtained.

In FIG. 5 a fifth poly-cantilever is shown. This poly-cantilever comprises two capture surface cantilevers 52, and a piezoresistive cantilever 51 with an integrated piezoresistive element 53. The piezoresistive cantilever 51 is linked to a substrate 54, and the capture surface cantilevers 52 are linked to the same substrate 54. The cantilever-like structures 51, 52 are connected to each other in areas where the cantilever-like structures 51, 52 pair wise comprise a protuberance 56. The cantilever connection lines C are therefore midlines through the protuberances 56 at the area where a line through is shortest.

The cantilever-like structures have equal length L, and the piezoresistive element 53 has an extension into the piezoresistive cantilever 51 to a distance DP from the substrate 54 which is about 80% of the length L of the protruding cantilever 51.

FIG. 6 shows a variation of the poly-cantilever shown in FIG. 5. The poly-cantilever comprises two capture surface cantilevers 62, and a piezoresistive cantilever 61 with an integrated piezoresistive element 63. The piezoresistive cantilever 61 is linked to a substrate 64, and the capture surface cantilevers 62 are linked to the same substrate 64.

The capture surface cantilevers 62 have a length L which is longer than the length LP of the piezoresistive cantilever 61. The piezoresistive element 63 has an extension into the piezoresistive cantilever 61 to a distance DP from the substrate 64 which is about 50% of the length of the piezoresistive cantilever 61. Due to the longer capture surface cantilevers 62 and shorter piezoresistive cantilever 61, the deflection of the piezoresistive cantilever 61 generated via the deflection of the capture surface cantilevers, will be concentrated on a shorter length and thereby a higher signal will be obtained.

In FIG. 7 a seventh poly-cantilever is shown. This poly-cantilever also comprises a capture surface cantilever 72, and a piezoresistive cantilever 71 with an integrated piezoresistive element 73. The piezoresistive cantilever 71 is linked to a substrate 74, and the capture surface cantilever 72 is linked to the same substrate 74.

The capture surface cantilever 72 has a periphery as a menhir seen in a side view, and is connected to the substrate 74 along connection line CL. The length of the capture surface cantilever 72 is illustrated with L and the connection distance for the capture surface cantilever 72 is illustrated D. As seen, the cantilever-like structures 71, 72 are connected to each other with a connection distance D of approximately 60% of the length L of the capture surface cantilever.

In FIG. 8 an eighth poly-cantilever is shown. This poly-cantilever comprises two capture surface cantilevers 82, and a piezoresistive cantilever 81 with an integrated piezoresistive element 83. The piezoresistive cantilever 81 is linked to a substrate 84, and the capture surface cantilevers 82 are linked to the same substrate 84.

The capture surface cantilevers 82 are linked to the piezoresistive cantilever 81. The cantilever-like structures 81, 82 are angled so that the angle a between the piezoresistive cantilever 81 and each of the capture surface cantilevers 82 is about 30°, and the angle between the two capture surface cantilevers 82 is about 60°.

The cantilever-like structures 81, 82 have equal length L, and the piezoresistive element 83 has an extension into the piezoresistive cantilever 81 to a distance from the substrate 84 which is about 80% of the length of the protruding cantilever 81.

In FIG. 9 a ninth poly-cantilever is shown. This poly-cantilever comprises two capture surface cantilevers 92, and a piezoresistive cantilever 91 with an integrated piezoresistive element 93. The piezoresistive cantilever 91 is linked to a substrate 94, and the capture surface cantilevers 92 are linked to the same substrate 94.

The cantilever connection lines are indicated with 96. The capture surface cantilevers 92 are leaf shaped with an opening 98 through the leaf structure. This opening 98 has the purpose of providing the capture surface cantilever 92 with an increased flexibility without loosing too much surface area for the capture coating.

The capture surface cantilevers 92 have equal length L, and piezoresistive cantilever 91 has a length LP which is shorter. The piezoresistive element 93 has an extension into the piezoresistive cantilever 91 to a distance from the substrate 94 which is about 30% of the length LP of the protruding cantilever 91.

In FIG. 10 a tenth poly-cantilever is shown. This poly-cantilever comprises two capture surface cantilevers 102, and a piezoresistive cantilever 101 with an integrated piezoresistive element 103. The piezoresistive cantilever 101 is linked to a substrate 104, and the capture surface cantilevers 102 are linked to the same substrate 104.

The cantilever connection lines are indicated with 106. The capture surface cantilevers 102 are curved. The capture surface cantilevers 102 have equal length L, and the piezoresistive cantilever has a length LP which is shorter. The piezoresistive element 103 has an extension into the piezoresistive cantilever 11 to a distance from the substrate which is about 50% of the length LP of the protruding cantilever 101.

1. A sensor comprising one or more sensor units, at least one of the sensor units being in the form of a poly-cantilever structure, said poly-cantilever structure comprise two or more cantilever-like structures at least one of the cantilever-like structures comprises a piezoresistive element, at least one of the cantilever-like structures comprises a capture surface, at least one cantilever-like structure with a piezoresistive element designated a piezoresistive cantilever being connected in an amplifying connection to at least one of the cantilever-like structures with a capture surface designated a capture surface cantilever, said amplifying connection being provided so that a deflection of said capture surface cantilever due to a stress generated at said capture surface being capable of deflecting the connected piezoresistive cantilever.

2. A sensor according to claim 1 wherein at least one of said cantilever-like structures being a sheet formed unit linked to a substrate and protruding there from, said cantilever preferably having a periphery which is selected between square formed, rectangular, triangular, pentagonal, hexagonal, leaf shaped, circular and oval periphery.

3. A sensor according to claim 2 wherein two or more, such as all of said cantilever-like structures being sheet formed units linked to a substrate and protruding there from, said cantilevers preferably having peripheries which are independently of each other selected between square formed, rectangular, triangular, pentagonal, hexagonal, leaf shaped, circular and oval peripheries.

4. A sensor according to claim 1 wherein each cantilever-like structures being linked to a substrate and protruding there from, the %-vice connection distance of a connection line of a first cantilever-like structure to another and the substrate linked to said first cantilever-like structure being determined as the shortest distance, and the %-vice distance being in % of total length of the protruding first cantilever-like structure, the two or more cantilever-like structures of a poly-cantilever structure preferably being connected to each other at a connection distance for one or preferably both cantilever-like structures which is 50% or more, such as 70% or more, Such as 90% or more.

5. A sensor according to claim 1 wherein the two or more cantilever-like structures of a poly-cantilever structure being connected to each other at their free ends, wherein the free end of a cantilever is the end which is farthest away from the substrate to which it is linked.

6. A sensor according to claim 1 wherein each cantilever-like structures being linked to a substrate and protruding there from, the connection between said cantilever-like structures being in the form of a connecting element such as a bridge, the connection element preferably having an average flexibility which is lower than the average flexibility of the piezoresistive cantilever

7. A sensor according to claim 1 wherein each cantilever-like structures being linked to a substrate and protruding there from, the connection between said cantilever-like structures being in the form of a joining along a length section of the periphery of the cantilever-like structures.

8. A sensor according to claim 1 wherein each cantilever-like structure of the poly-cantilever structure having an essentially rectangular or square formed periphery, the two or more cantilever-like structures of the poly-cantilever structure being connected to each other at their free edge, wherein the free edge of a cantilever is the edge which is farthest away from the substrate to which it is linked, the piezoresistive cantilever preferably being connected to the one or more other cantilever-like structures along 60% or less, such as 40% or less, such as 20% or less of the length of the free edge of the piezoresistive cantilever, more preferably said connection preferably being located to at least cover the median of the free edge line.

9. A sensor according to claim 1 wherein two or more, preferably each cantilever-like structure of the poly-cantilever structure protrudes in directions from their respective substrates which directions has/have an angle or angles to each other which is/are within the interval 0 to 45°, preferably the directions has/have an angle or angles to each other which is/are within the interval 0 to 15°.

10. A sensor according to claim 1 wherein said poly-cantilever structure comprises two cantilever-like structure, one or both of the cantilever-like structures comprises a capture surface of at least one of its major surfaces.

11. A sensor according to claim 1 wherein said poly-cantilever structure comprises two, tree or four cantilever-like structures, the cantilever-like structures preferably having equal shape.

12. A sensor according to claim 1 wherein said cantilever-like structures having two opposite major surfaces each, the major surfaces of the capture surface cantilever preferably having a larger area than the major surfaces of the piezoresistive cantilever.

13. A sensor according to claim 1 wherein said piezoresistive cantilever has a flexibility which is varying over extension from the substrate and towards its free end, the flexibility preferably being highest at a distance from the substrate which is 50% or less, such as 30% or less of the length of the protruding cantilever.

14. A sensor according to claim 1 wherein the capture surface cantilever comprises an antibody layer.

15. A sensor according to claim 1 wherein the cantilever-like structures being made from materials selected from silicon, silicon oxide, silicon nitride, metals, polymers, glass compositions, ceramics, plastics or any combinations of these materials.

16. A sensor according to claim 1 wherein the piezoresistor consist of one or more of the materials amorph silicon, polysilicon, single crystal silicon, metal or metal containing composition, e.g. gold, AlN, Ag, Cu, Pt and Al conducting polymers, such as doped octafunctional epoxidized novalac e.g. doped SU-8, and composite materials with an electrically non-conducting matrix and a conducting filler, wherein the filler preferably is selected from the group consisting of amorph silicon, polysilicon, single crystal silicon, metal or metal containing composition, e.g. gold, AlN, Ag, Cu, Pt and Al, semi-conductors, carbon black, carbon fibres, particulate carbon, carbon nanowires, silicon nanowires.

17. A sensor according to claim 1 wherein the capture surface cantilever being placed in a flow system.

18. A sensor according to claim 1 wherein said sensor comprises one or more fluid chambers, said one or more sensor units partly or totally protrudes into said fluid chamber(s) so that a fluid applied in the chamber is capable of coming into contact with the capture surface of the sensor unit(s).

19. A sensor according to claim 1 wherein said fluid chamber or chambers is/are in the form of interaction chamber(s), preferably comprising a channel for feeding a fluid into the interaction chamber(s).
